(19) United States
(12) Patent Application Publication
(10) Pub. No.: US 2026/0097596 A1
(43) Pub. Date: Apr. 9, 2026

(54) SHEET CONVEYING DEVICE AND IMAGE FORMING SYSTEM

(71) Applicant: CANON KABUSHIKI KAISHA, Tokyo (JP)

(72) Inventor: MAKOTO TANAKA, Chiba (JP)

(21) Appl. No.: 19/341,710

(22) Filed: Sep. 26, 2025

(30) Foreign Application Priority Data
Oct. 8, 2024 (JP) 2024-176500

(51) Int. Cl. B41J 13/03; B41J 13/02

(52) U.S. Cl. CPC B41J 13/03; B41J 13/025

(57) ABSTRACT

A sheet conveying device includes first and second members and an urging member. The first member is rotatable, displaceable to closed, open and intermediary positions and includes an engaging portion. The second member is rotatable in a different direction of the first member, displaceable to closed and open positions and includes an engaged portion. The urging portion urges to move the first member toward the closed position when in a first range from the closed position to the intermediary position, and to move toward the closed position when in a second range from the intermediary position to the open position. When the first member and the second member are in the closed position, the engaging portion is engaged with the engaged portion, and when the first member is moved from the closed position to the open position, the second member is moved to the open position and retained.

### BACKGROUND

### Field of the Technology

The present invention relates to a sheet conveying device for conveying a sheet and an image forming system which applies it.

### Description of the Related Art

Conventionally, in an image forming apparatus such as a printer and a copier, the image forming apparatus, which is provided with the sheet conveying device which conveys the sheet which is a recording material, is widely used (Japanese Laid-Open Patent Application (JP-A) 2011-11838). The sheet conveying device is provided, for example, to convey the sheet in a buffer path which connects a main assembly of the image forming apparatus and a finisher which is a post processing device. In the sheet conveying device, a door, which is provided with the main assembly of the image forming apparatus, is provided rotatably and openably/closably by a rotational shaft with respect to an up-down direction. Further, among an upper guide member and a lower guide member which form the buffer path, the lower guide member is provided rotatably and openably/closably by a rotational shaft with respect to a left-right direction (a sheet width direction which is perpendicular to a sheet conveyance direction). Further, a guide member which is defined as the upper guide member is provided above the door. In this way, rotational directions, in which the door and the lower guide member rotate, are different each other, and rotational loci of the door and the lower guide member are overlapped.

The lower guide member is locked in a closed position with respect to the upper guide member by a guide hook which is rotatably provided with a latch shaft. Further, when the door is opened, a contacting portion of an upper portion of the door contacts and presses against an unlocking member of a latch shaft, and releases the lock of the lower guide member which is locked by the guide hook. As a result, the lower guide member rotates downward by its own weight and the buffer path is released. By this configuration, it is possible to open the door and the lower guide member in a single operation by interrelating with them, even when the rotational directions of the door and the lower guide member are different each other, and it is possible to improve an operability when opening a conveying passage due to a jam processing, etc. However, in the sheet conveying device which is described in JP-A 2011-11838 which is described above, it is not possible to apply to a configuration in which, for example, the lower guide member rotates upward, since the lower guide member rotates by its own weight after releasing the lock of the lower guide member by the door.

### SUMMARY

In response to the above issue, it is an object of the present invention to provide a sheet conveying device and an image forming system in which, for two rotatable members having mutually different rotational axes, it is possible to interrelate with the other member to rotate upward against gravity by rotating one member.

According to an aspect of the present invention, there is provided a sheet conveying device comprising: a first rotatable member rotatable about a first rotational shaft, displaceable to a first position where the first rotatable member is closed, a second position where the first rotatable member is opened upward from the first position and a third position positioned between the first position and the second position, and including an engaging portion; a second rotatable member rotatable about a second rotational shaft which is disposed in a direction crossing the first rotational shaft, displaceable to a fourth position where the second rotatable member is closed and a fifth position where the second rotatable member is opened upward from the fourth position, and including an engaged portion engageable with the engaging portion; and an urging portion configured to urge so as to move the first rotatable member toward the first position in a case in which the first rotatable member is positioned in a first range from the first position to the third position, and to urge so as to move the first rotatable member toward the second position in a case in which the first rotatable member is positioned in a second range from the third position to the second position, wherein in a state in which the first rotatable member is in the first position and the second rotatable member is in the fourth position, the engaging portion is engaged with the engaged portion, and in a case in which the first rotatable member is moved from the first position to the second position, the second rotatable member is moved to the fifth position and retained.

According to another aspect of the present invention, there is provided an image forming system comprising: an image forming apparatus including an image forming portion configured to form an image on a sheet and the sheet conveying device which is described above.

Further features of the present disclosure will become apparent from the following description of exemplary embodiments with reference to the attached drawings.

### BRIEF DESCRIPTION OF THE DRAWINGS

FIG. 1 is a sectional view showing an image forming system according to an embodiment.

Part (a) and part (b) of FIG. 2 are schematic front views showing feeding modules according to the embodiment, part (a) of FIG. 2 is the view showing conveying passages, and part (b) of FIG. 2 is the view showing the conveying passages in a case of connecting two units along the sheet conveyance direction.

Part (a) and part (b) of FIG. 3 are perspective views showing opened/closed states of an upper unit in the feeding module according to the embodiment, part (a) of FIG. 3 is the view showing the upper unit in the closed state, and part (b) of FIG. 3 is the view showing the upper unit in an opened state.

Part (a) of FIG. 4 is a side view of the upper unit and a merging guide viewed from a positive side to a negative side in an X direction, and part (b) of FIG. 4 is a sectional view showing a state which is cut along line A-A in part (a) of FIG. 4, in a state in which the upper unit is closed according to the embodiment.

FIG. 5 is a perspective view showing a lever according to the embodiment.

Part (a) of FIG. 6 is a side view of the upper unit and the merging guide viewed from the positive side to the negative side in the X direction, and part (b) of FIG. 6 is a sectional view showing a state which is cut along line B-B in part (a) of FIG. 6, in a state in which the upper unit is opened by 8 degrees according to the embodiment.

FIG. 7 is a graph showing a relationship between an own weight of the merging guide and a moment of a tension coil spring according to the embodiment.

Part (a) of FIG. 8 is a side view of the upper unit and the merging guide viewed from the positive side to the negative side in the X direction, and part (b) of FIG. 8 is a sectional view showing a state which is cut along line C-C in part (a) of FIG. 8, in a state in which the upper unit is opened by 23 degrees which is a maximum angle according to the embodiment.

Part (a) of FIG. 9 is a side view of the upper unit and the merging guide viewed from the positive side to the negative side in the X direction, and part (b) of FIG. 9 is a sectional view showing a state which is cut along line D-D in part (a) of FIG. 9, in a state in which the upper unit is opened by 11 degrees according to the embodiment.

Part (a) of FIG. 10 is a side view of the upper unit and the merging guide viewed from the positive side to the negative side in the X direction, and part (b) of FIG. 10 is a sectional view showing a state which is cut along line E-E in part (a) of FIG. 10, in a state in which the upper unit is opened by 23 degrees and the merging guide is closed according to the embodiment.

Part (a) of FIG. 11 is a side view of the upper unit and the merging guide viewed from the positive side to the negative side in the X direction, and part (b) of FIG. 11 is a sectional view showing a state which is cut along line F-F in part (a) of FIG. 11, in a state in which the upper unit is opened by 5 degrees and the merging guide is closed according to the embodiment.

Part (a) of FIG. 12 is a side view of the upper unit and the merging guide viewed from the positive side to the negative side in the X direction, and part (b) of FIG. 12 is a sectional view showing a state which is cut along line G-G in part (a) of FIG. 12, in a state in which the upper unit is opened by 3 degrees and the merging guide is closed according to the embodiment.

### DESCRIPTION OF THE EMBODIMENTS

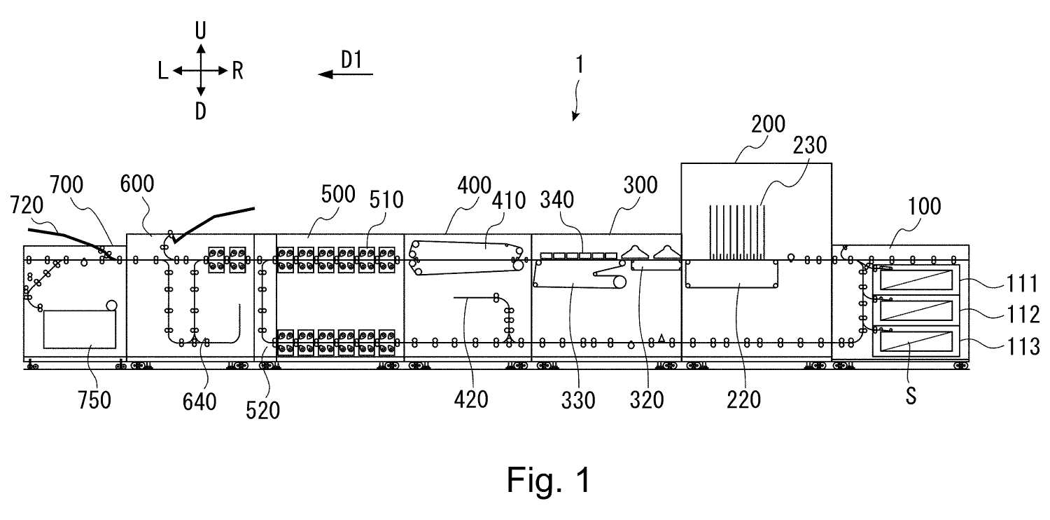

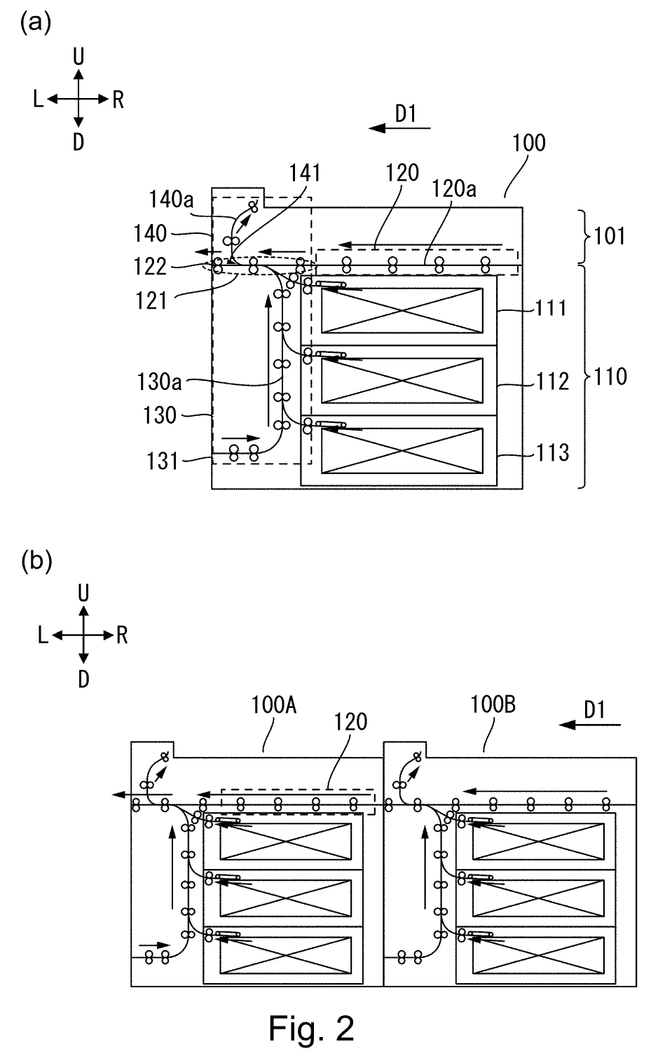

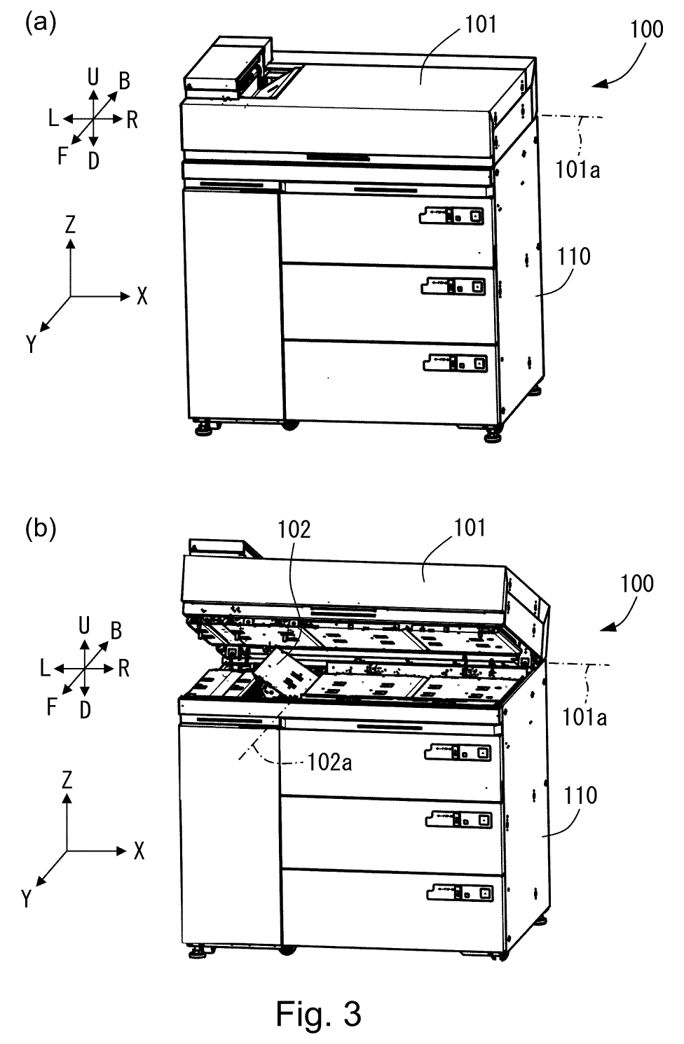

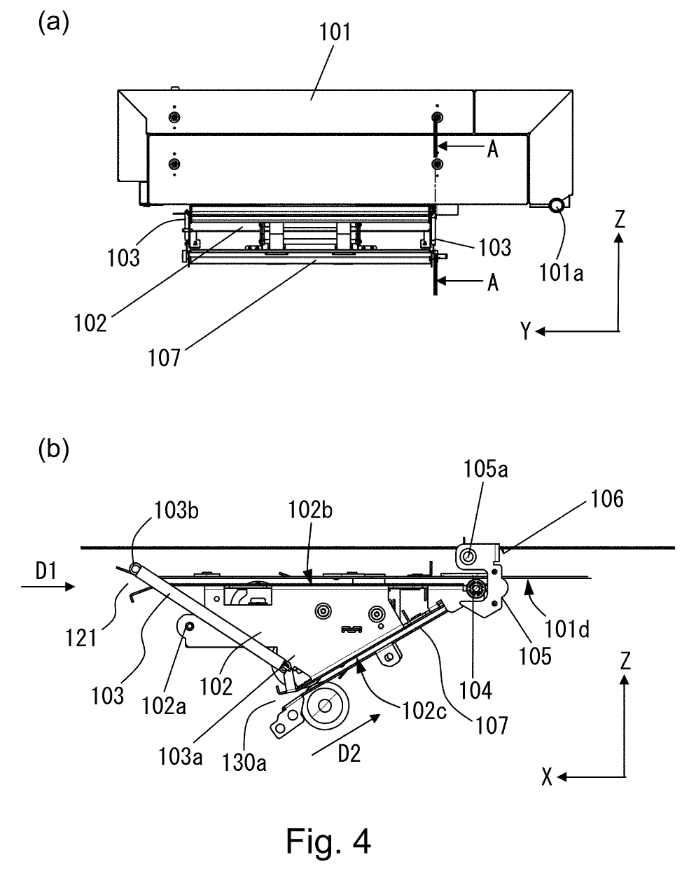

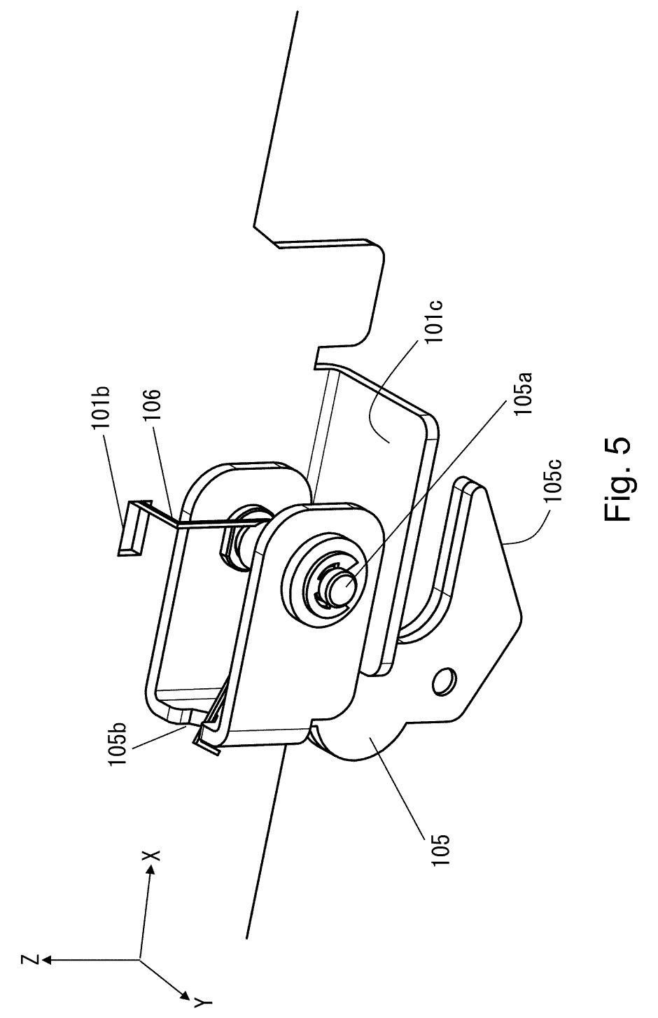

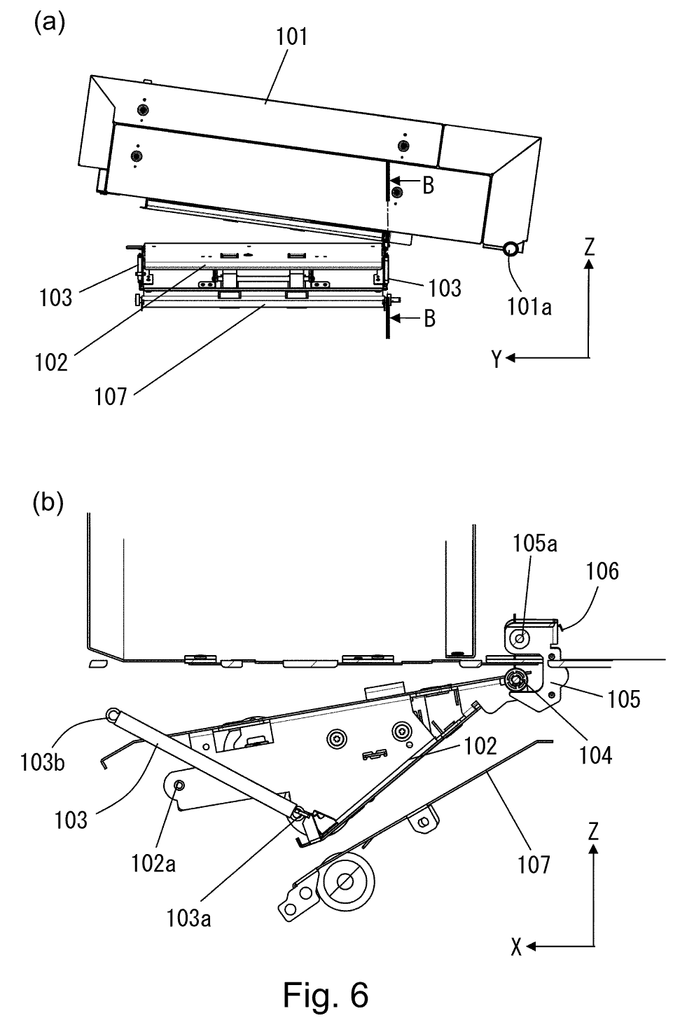

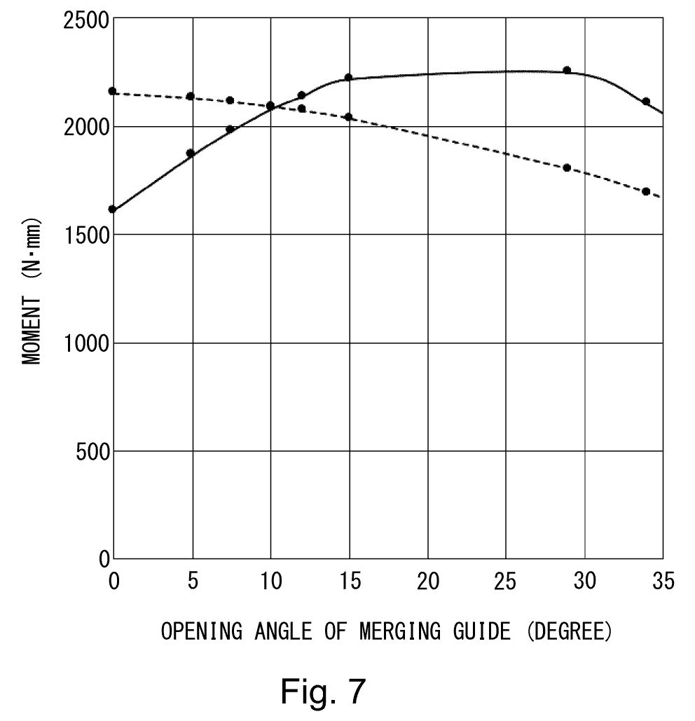

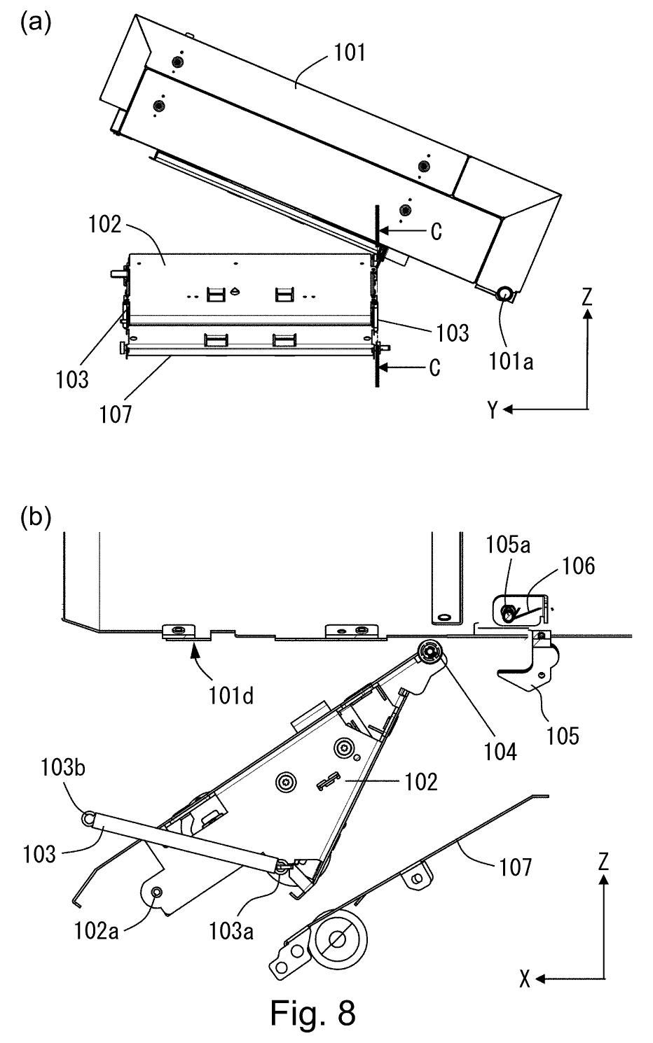

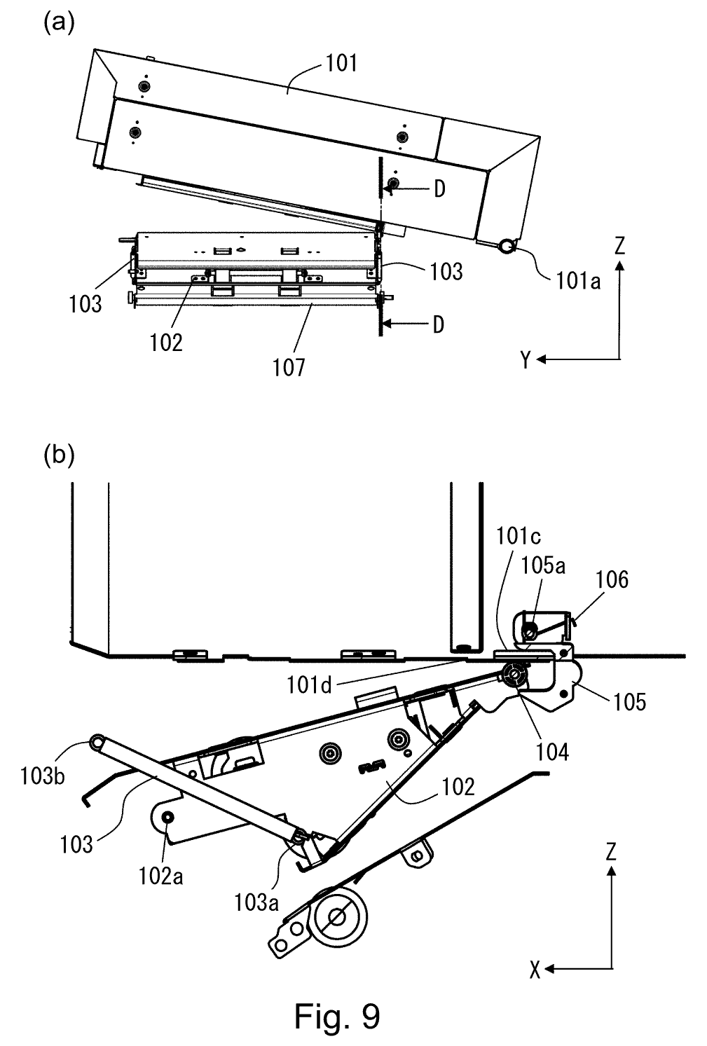

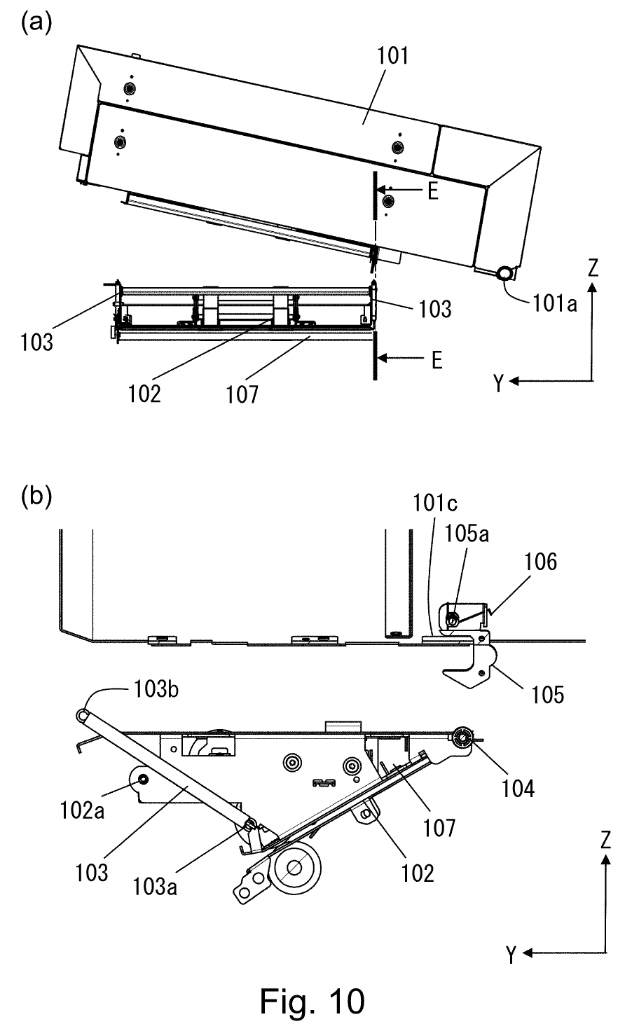

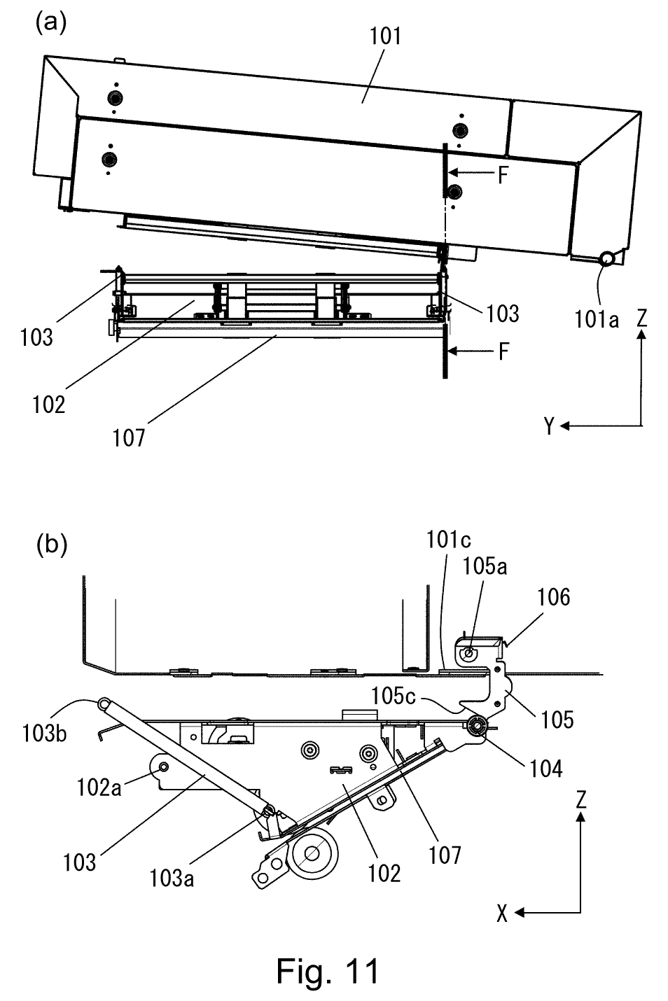

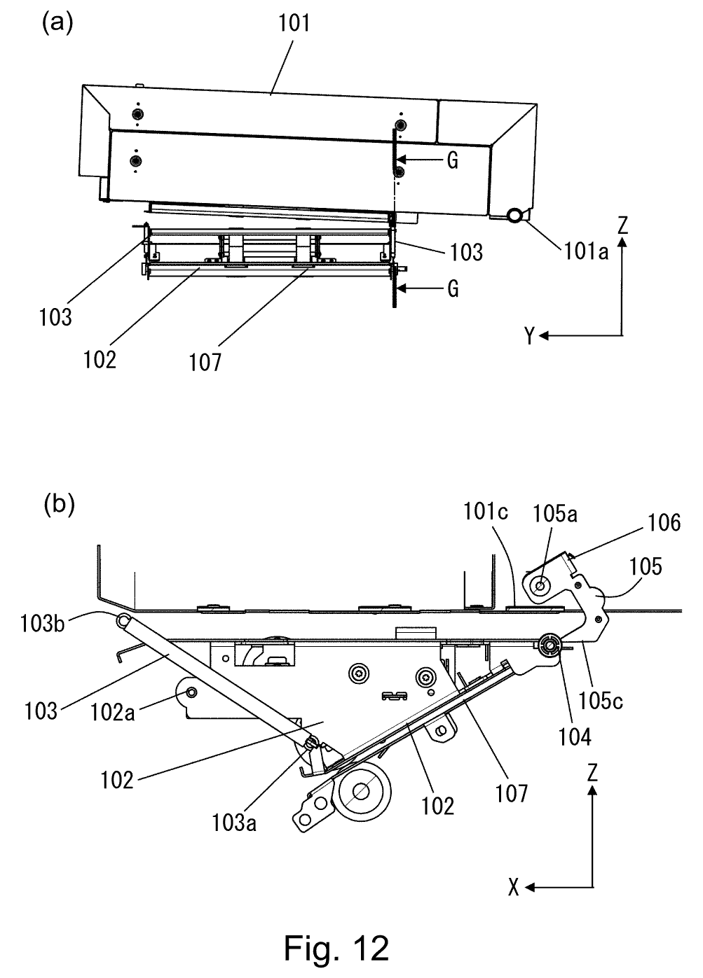

In the following, an embodiment of the present invention will be specifically described with reference to FIGS. 1 through part (b) of FIG. 12. In the embodiment, a case in which an image forming system is applied to an inkjet recording system 1 will be described. FIG. 1 is a schematic diagram showing one of examples of a schematic configuration of the inkjet recording system 1. The inkjet recording system 1 is a sheet-fed type inkjet recording system which produces a recording material by forming an ink image on a sheet S using two kinds of liquids which are a reaction fluid and an ink. As shown in FIG. 1, the inkjet recording system 1 is configured of a feeding module 100, a printing module 200, a drying module 300, a fixing module 400, a cooling module 500, a reversing module 600, and a discharging module 700. The sheet S whose shape is cut paper and which is supplied from the feeding module 100 is conveyed along a conveying passage, processed at each module, and discharged in the discharging module 700. Incidentally, the sheet in the embodiment refers to a recording material and includes paper such as a sheet and an envelope, plastic film such as an overhead projector sheet (OHP), cloth, etc. Further, in the embodiment, a sheet conveyance direction D1 is disposed in a left-right direction of the inkjet recording system 1, and a right side as viewed from a front is referred to as a right direction R, a left side as viewed from the front is referred to as a left direction L, a front side is referred to as a front direction F, a rear side is referred to as a back direction B, an upper side is referred to as an upward direction U, and a lower side is referred to as a downward direction D.

The feeding module 100 is one of examples of a sheet conveying device which conveys the sheet S, and when it is connected to the printing module 200 and conveys the sheet, the sheet is supplied to the printing module 200 and the sheet is delivered between the feeding module 100 and the printing module 200. The feeding module 100 includes three storage compartments 111, 112, and 113 which accommodate the sheet S. Each of the storage compartments 111, 112, and 113 is configured so that it is possible to draw out to a front surface side of the apparatus. The sheet S is fed one by one in each of the storage compartments 111, 112, and 113 by a separating belt and a conveying roller which are not shown, and is conveyed to the printing module 200. Incidentally, the number of the storage compartments 111, 112, and 113 is not limited to three, however, it may also be configurations which include one, two, or four or more. The feeding module 100 will be described below.

The printing module 200 is one of examples of an image forming apparatus, includes a pre-imaging registration correcting portion which is not shown, a print belt unit 220, and a recording portion 230, and conveys the sheet S. The sheet S, which is conveyed from the feeding module 100, is corrected for inclination and position by the pre-imaging registration correcting portion, and the sheet S is conveyed to the print belt unit 220. The recording portion 230 is disposed at a position opposed to the print belt unit 220 with respect to the conveying passage. The recording portion 230 is one of examples of an image forming portion, and forms an image on the sheet S which is conveyed when recording heads perform recording processing (printing) on the sheet S from above. The recording heads are arranged in a plurality along the conveying direction. In the embodiment, the recording portion 230 includes a total of five of the line type recording heads which correspond to four colors of Y (Yellow), M (Magenta), C (Cyan), and Bk (Black) and additionally a reaction fluid. Incidentally, the number of colors is not limited to four, and the number of the recording heads is not limited to five. As an inkjet type, it is possible to adopt a type which applies a heating element, a type which applies a piezoelectric element, a type which applies an electrostatic element, a type which applies a MEMS element, etc. Each color ink is supplied to each of the recording heads via each of ink tubes from each of ink tanks which are not shown. When the sheet S, which is printed in the recording portion 230, is sucked and conveyed by the print belt unit 220, the sheet S is conveyed while a clearance with the recording head is maintained. The sheet S, which is printed by the recording portion 230, is detected for a misalignment and a color density of the image which is formed on the sheet by an inline scanner which is not shown and disposed on a downstream side of the recording portion with respect to the sheet conveyance direction. The detected result is used for correcting an image to be printed.

The drying module 300 includes a decoupling portion 320, a drying belt unit 330, and a warm air blowing portion 340, and the drying module 300 reduces a liquid content which is contained in an ink which is applied onto the sheet S in the recording portion 230 of the printing module 200 and increases a fixing property between the sheet S and the ink. The sheet S, which is printed in the recording portion 230 of the printing module 200, is conveyed to the decoupling portion 320 which is disposed in an upstream side of the drying module 300 with respect to the sheet conveyance direction. It is possible to convey the sheet S by an air pressure from above and a belt friction in the decoupling portion 320, and the misalignment of the sheet S on the print belt unit 220, in which an ink image is formed, is prevented by conveying the sheet S on the belt while holding it lightly. The drying belt unit 330 is disposed below the belt and the warm air blowing portion 340 is disposed above the belt, while the belt is nipped by the drying belt unit 330 and the warm air blowing portion 340 which are opposed each other. The sheet S which is conveyed from the decoupling portion 320 is sucked and conveyed on the drying belt unit 330, and, at the same time, a surface, on which the ink is applied, is dried by a warm air which is blown from the warm air blowing portion 340. Incidentally, a drying type may be configured by combining a type in which an electromagnetic wave (ultraviolet ray, infrared ray) is irradiated onto the surface of the sheet S and a conductive heat transfer type in which a heating element is contacted, in addition to the type in which the warm air is applied.

The fixing module 400 includes a fixing belt unit 410. The fixing belt unit 410 includes an upper belt unit and a lower belt unit, and it is possible to fix the ink on the sheet S by passing the sheet S, which is conveyed from the drying module 300, between the upper belt unit and the lower belt unit which are heated.

The cooling module 500 includes a plurality of cooling portions 510, and it cools the sheet S at a high temperature, which is conveyed through a sheet conveying passage from the fixing module 400. The cooling portion 510 is configured so that the sheet S is cooled by taking outside air into a cooling box with a fan, increasing a pressure inside the cooling box, and applying an air which is blown from a nozzle which is formed on a conveying guide onto the sheet S. The cooling portion 510 is disposed on both an upper side and a lower side with respect to the conveying passage and cools the sheet S from both side surfaces.

Further, the cooling module 500 includes a conveying passage switching portion 520, and it is possible to switch the conveying passages of the sheet S depending on whether a case of conveying the sheet S to the reversing module 600 or a case of conveying the sheet S to a conveying passage for a double-sided printing when it is printed on both sides. The sheet S is conveyed to the conveying passage in a lower portion of the cooling module 500, when it is printed on both sides. In the case, the sheet S is furthermore conveyed through the conveying passage for the double-sided printing of the fixing module 400, the drying module 300, the printing module 200, and the feeding module 100, from the cooling module 500. The conveying passage for the double-sided printing of the fixing module 400 is provided with a first reversing portion 420 which reverses a front side and a back side of the sheet S. And, again, the sheet S is conveyed from the feeding module 100 to the pre-imaging registration correcting portion of the printing module 200, the print belt unit 220, and the recording portion 230, and is printed in the recording portion 230.

The reversing module 600 includes a second reversing portion 640 and it is possible to reverse the front side and the back side of the sheet S which is conveyed, so it is possible to change a front and back direction of the sheet S which is discharged. The discharging module 700 includes a top tray 720 and a stacking portion 750, and it aligns and stacks the sheet S which is conveyed from the reversing module 600.

### Feeding Module

Next, a configuration of the feeding module 100 will be described with reference to part (a) and part (b) of FIG. 2. Part (a) and part (b) of FIG. 2 are schematic diagrams showing a configuration of the feeding module 100. Part (a) of FIG. 2 is a front view showing the conveying passages in the feeding module 100, and part (b) of FIG. 2 is a front view showing the feeding module 100 in a case of connecting two units along the sheet conveyance direction D1. The feeding module 100 includes a horizontal conveying portion 120, a vertical conveying portion 130, and an escape conveying portion 140. The horizontal conveying portion 120 includes a horizontal conveying passage 120a which is in a horizontal direction, the vertical conveying portion 130 includes a vertical conveying passage 130a which conveys the sheet in the upward direction U, and the escape conveying portion 140 includes an escape conveying passage 140a which conveys the sheet in the upward direction U. In a downstream side of the horizontal conveying passage 120a with respect to the sheet conveyance direction D1, a discharging passage 121 which is formed by an upper portion of the vertical conveying portion 130 and a lower portion of the escape conveying portion 140 is continuously provided.

In a case of supplying the sheet S from the feeding module 100 to the printing module 200 which is disposed on a downstream side of the feeding module 100 with respect to the sheet conveyance direction D1, a following operation is executed. In a case of printing a first surface side of the sheet S, the sheet S is supplied from the storage compartments 111, 112, and 113. In a case of printing a second surface side of the sheet S, the sheet S is supplied from a reconveying passage (see FIG. 1) which is provided in a lower portion of the printing module 200, via a vertical conveying inlet 131 and through the vertical conveying passage 130a of the vertical conveying portion 130. Each of the sheets which are supplied is conveyed to the printing module from the discharging passage 121 via a discharging port 122.

A switching portion 141 is provided with the discharging passage 121. The switching portion 141 is capable of switching the conveying passages by rotation, and it switches whether the sheet which is conveyed through the discharging passage 121 is conveyed to the discharging port 122, or the sheet is conveyed to the escape conveying passage 140a of the escape conveying portion 140. In a case in which a jam or a malfunction is occurred during printing, the switching portion 141 switches the conveying passage to the escape conveying passage 140a of the escape conveying portion 140, and escapes the sheet which is remained in the conveying passage to a discharging tray which is provided with an upper portion of the feeding module 100.

The feeding module 100 can be added by connecting a plurality of units in series along the sheet conveyance direction D1, as shown in part (b) of FIG. 2. For example, a first feeding module 100A which is connected to the printing module 200 and a second feeding module 100B which is added can be connected in series along the sheet conveyance direction D1. In the case, the sheet which is supplied from the second feeding module 100B is conveyed in the horizontal conveying portion 120 of the first feeding module 100A, is passed through the discharging passage 121, and is discharged to the printing module 200 similar to the sheet which is supplied from the first feeding module 100A.

### Opening/closing of upper unit in the feeding module

In the following, an operation of opening the feeding module 100, when performing jam processing, etc., will be described with reference to part (a) and part (b) of FIG. 3. In part (a) of FIG. 3 and subsequent figures, the right direction R in the left-right direction is referred to as an X direction, the front direction F in a front-back direction is referred to as a Y direction, and the upward direction U in the up-down direction is referred to as a Z direction. The feeding module 100 includes a lower unit 110 which accommodates the storage compartments 111, 112, and 113, and an upper unit 101 which is disposed above the lower unit 110 and is openably/closably by rotation with respect to the lower unit 110. The horizontal conveying passage 120a and the discharging passage 121 are formed between the upper unit 101 and the lower unit 110.

The upper unit 101 is one of examples of a second rotatable member and is rotatably provided around an upper rotational shaft 101a which is one of examples of a second rotational shaft in which the X direction is set as its longitudinal direction. The upper unit 101 includes a guide surface which forms the horizontal conveying passage 120a and the discharging passage 121 opposed to the lower unit 110 in a lower portion of the upper unit 101, and it is capable of opening/closing the horizontal conveying passage 120a and the discharging passage 121 by rotation. The upper unit 101 is displaceable to a fourth position in which it is closed (see part (a) of FIG. 3) and a fifth position in which it is opened upward from the fourth position (see part (b) of FIG. 3). The upper unit 101 forms the horizontal conveying passage 120a and the discharging passage 121 at the fourth position, and opens the horizontal conveying passage 120a and the discharging passage 121 at any other positions. Incidentally, the upper unit 101 is supported by a gas spring which is not shown.

The lower unit 110 includes a guide surface which forms the horizontal conveying passage 120a and the discharging passage 121 opposed to the upper unit 101 in a upper portion of the lower unit 110. On the guide surface of the lower unit 110, a merging guide 102 which is a guide member is provided on an upstream side of a position in which the vertical conveying passage 130a is merged with the discharging passage 121 with respect to the sheet conveyance direction D1. The merging guide 102 is one of examples of a first rotatable member, and it is a conveying guide which guides the sheet which is conveyed in the vertical conveying passage 130a to the discharging passage 121.

The merging guide 102 is disposed below the upper unit 101 and it includes a first guide portion 102b. The first guide portion 102b is a guide surface opposed to the upper unit 101 which is positioned in the fourth position in a case in which the merging guide 102 is positioned in a first position. The upper unit 101 includes a conveying guide portion 101d which is one of examples of a second guide portion opposed to the merging guide 102 which is positioned in the first position in a case of being positioned in the fourth position. The first guide portion 102b and the conveying guide portion 101d form the discharging passage 121 which is one of examples of a first conveying passage which conveys the sheet between them. Further, a lower guide member 107 is disposed below the merging guide 102 which is positioned in the first position. The merging guide 102 includes a third guide portion 102c opposed to the lower guide member 107 in a case of being positioned in the first position. The third guide portion 102c and the lower guide member 107 form the vertical conveying passage 130a which is one of examples of a second conveying passage which conveys the sheet S between them.

Jam may be occurred at a position in which the vertical conveying passage 130a is merged with the discharging passage 121, and jam processing is required in the case. In the case, in order to easily process the sheet which is jammed, the merging guide 102 is designed to open upward, as shown in part (b) of FIG. 3. The merging guide 102 is rotatably provided around a lower rotational shaft 102a which is one of examples of a first rotational shaft in which the Y direction is set as its longitudinal direction. The merging guide 102 is displaceable to the first position in which it is closed (see part (b) of FIG. 4), a second position in which it is opened upward from the first position (see part (b) of FIG. 3), and a third position in which it is positioned between the first position and the second position (see part (b) of FIG. 6).

In the embodiment, the upper rotational shaft 101a, which is a rotational shaft of the upper unit 101, is disposed so that the sheet conveyance direction D1 (X direction) of the sheet which is conveyed is its longitudinal direction. Further, the lower rotational shaft 102a, which is a rotational shaft of the merging guide 102, is disposed so that a width direction (Y direction) which is perpendicular to the sheet conveyance direction D1 is its longitudinal direction. The upper rotational shaft 101a and the lower rotational shaft 102a are in a crossed positional relationship, that is, a twisted positional relationship, and an axis of the upper rotational shaft 101a and an axis of the lower rotational shaft 102a are not in an intersecting positional relationship each other in the embodiment. However, the present invention is not limited to this, the axes may intersect each other. Alternatively, the present invention is not limited to that the upper rotational shaft 101a and the lower rotational shaft 102a are perpendicular when it is viewed from above, however, the upper rotational shaft 101a and the lower rotational shaft 102a may be set at any angle other than parallel. In this way, since directions of rotational axes of the upper unit 101 and the merging guide 102 are different and are disposed in a position so that they are overlapped in the up-down direction, each of rotational loci is overlapped.

### Interlocking between upper unit and merging guide

The merging guide 102 and the upper unit 101 will be described with reference to part (a) and part (b) of FIG. 4. Part (a) of FIG. 4 is a side view of the upper unit 101 and the merging guide 102 when they are viewed from the positive side to the negative side in the X direction while the upper unit 101 is closed, and part (b) of FIG. 4 is a sectional view showing a state when they are cut along line A-A in part (a) of FIG. 4. The merging guide 102 is a part which is configured of a portion of the discharging passage 121 and a portion of the vertical conveying passage 130a. The lower guide member 107 is provided in the downward direction D of the merging guide 102. The escape conveying portion 140 in the upper unit 101 and the merging guide 102 form a portion of the discharging passage 121, and the merging guide 102 and the lower guide member 107 form a portion of the vertical conveying passage 130a.

As shown in part (b) of FIG. 4, the sheet conveyance direction D1 in the discharging passage 121 is horizontal, and the sheet conveyance direction D2 in the vertical conveying passage 130a is diagonally upward toward the discharging passage 121. The merging guide 102 is rotatable around a Y axis as centered on the lower rotational shaft 102a, and tension coil springs 103 are provided on both end portions with respect to the Y direction. The tension coil spring 103 is connected to the merging guide 102 at an end portion 103a on a lower side of the tension coil spring 103, it is connected to a frame of the lower unit 110 at an end portion 103b on an upper side of the tension coil spring 103, and it urges in a direction of standing upright against its own weight with respect to the merging guide 102. That is, the tension coil spring 103 is one of examples of a second urging portion, and urges the merging guide 102 toward the second position. A roller 104 is provided on a leading end portion of the merging guide 102 in -X direction, when the merging guide 102 is positioned in the first position. The roller 104 is one of examples of an engaging portion and is rotatable with respect to the merging guide 102.

On the other hand, the upper unit 101 is rotatable around the X axis as centered on the upper rotational shaft 101a, and it includes a lever 105 at a position in which the roller 104 of the merging guide 102 is provided in the Y direction. FIG. 5 is a perspective view specifically showing the lever 105. The lever 105 is rotatable around a rotational shaft 105a in which the Y direction is designed as an axis direction. The lever 105 is one of examples of an engaged portion and it is capable of engaging with the roller 104. That is, the lever 105 is one of examples of a hook which is rotatably supported at an engaging position in which it engages the roller 104, and a retracted position in which it retracts from the roller 104, with respect to the upper unit 101. In the embodiment, the roller 104 engages with the lever 105 in a case in which the merging guide 102 is positioned in the first position and the upper unit 101 is positioned in the fourth position.

A twisted coil spring 106 which is wound around the rotational shaft 105a is provided with the lever 105. One end portion of the twisted coil spring 106 engages with an engaging hole 101b which is formed in a frame of the upper unit 101, while the other end portion of the twisted coil spring 106 engages with a notched portion 105b in the lever 105. While the twisted coil spring 106 presses the lever 105 against a contacting surface 101c of the frame of the upper unit 101, it is possible to rotate the lever 105 when a moment against an urging force of the twisted coil spring 106 is received. The twisted coil spring 106 is one of examples of a first urging portion and it urges the lever 105 toward the engaging position.

Part (a) of FIG. 6 is a side view of the upper unit 101 and the merging guide 102 when they are viewed from the positive side to the negative side in the X direction, in a state that the upper unit 101 is rotated by 8 degrees around the upper rotational shaft 101a with respect to a state that the upper unit 101 is closed. Part (b) of FIG. 6 is a sectional view showing a state when they are cut along line B-B in part (a) of FIG. 6. At this time, when the lever 105 and the roller 104 are contacted according to the rotation of the upper unit 101, the merging guide 102 is pulled up around the lower rotational shaft 102a and is rotated by 10 degrees.

That is, in a case in which the upper unit 101 is rotated from the fourth position toward the fifth position, the merging guide 102 is rotated from the first position toward the third position when the roller 104 engages with the lever 105. Here, in a case in which the merging guide 102 is positioned within a first range (the opening angle is between 0 degree and 10 degrees) which will be described below and an engaging portion of the lever 105 is positioned below the roller 104, the lever 105 engages with the roller 104 so that the lever 105 does not rise above the roller 104.

Here, a moment in which the merging guide 102 is received will be described with reference to a graph which is shown in FIG. 7. FIG. 7 is a graph showing a relationship between an own weight of the merging guide 102 and a moment of the tension coil spring 103. A horizontal axis of the graph indicates the opening angle of the merging guide 102, and a vertical axis of the graph indicates the moment in which the merging guide 102 is received around the lower rotational shaft 102a. A solid line in the graph indicates a moment in a direction in which the tension coil spring 103 opens the merging guide 102, and a dotted line indicates a moment in a direction in which the merging guide 102 is closed by its own weight. Incidentally, in the embodiment, a weight of the merging guide 102 is 19.6N, and a tension force of the tension coil spring 103 is 70N per spring in a state that the merging guide 102 is closed.

As shown in FIG. 7, when the opening angle of the merging guide 102 is from 0 degree to 10 degrees, the moment in the direction in which the merging guide 102 is closed by its own weight is greater than the moment in the direction in which the tension coil spring 103 opens the merging guide 102. Therefore, the merging guide 102 is in the closed state due to its own weight.

When the opening angle of the merging guide 102 which is shown in part (a) and part (b) of FIG. 6 reaches 10 degrees, the moments in the opening direction and the closing direction are balanced, and when the opening angle of the merging guide 102 exceeds 10 degrees, the moment in the opening direction by the tension coil spring 103 becomes greater. That is, in a case in which the merging guide 102 is positioned in the first range, an urging force of the tension coil spring 103 is smaller than the moment which is caused by the weight of the merging guide 102, and in a case in which the merging guide 102 is positioned in the second range, the urging force of the tension coil spring 103 is greater than the moment which is caused by the weight of the merging guide 102.

Therefore, in a case in which the opening angle of the merging guide 102 is between 0 degree and 10 degrees, the merging guide 102 is pulled up by the lever 105. That is, in a case in which the merging guide 102 is positioned in the first range (the opening angle is between 0 degree and 10 degrees) and the roller 104 is engaged with the lever 105, the merging guide 102 rotates in interrelation with the upper unit 101. On the other hand, in a case in which the opening angle greater than 10 degrees, the merging guide 102 will open due to the urging force of the tension coil spring 103 even when the lever 105 does not contact the roller 104.

That is, in a case in which the merging guide 102 is positioned in the first range which is from the first position (the opening angle is 0 degree) to the third position (the opening angle 10 degrees) and an external force is not applied, the merging guide 102 is stopped in the first position. However, it is not limited to stopped in the first position, but it may be stopped at any position in the first range. Further, in a case in which the merging guide 102 is positioned in the second range from the third position (the opening angle 10 degrees) to the second position (the opening angle is 34 degrees), and an external force is not applied, the merging guide 102 is stopped in the second position. However, it is not limited to stopped in the second position, but it may be stopped at any position in the second range. Further, in the embodiment, the first position is a horizontal position, and a rotation angle from the first position to the second position in the merging guide 102 is less than 90 degrees. In this way, it is possible to prevent to be configured so that the opening state is ensured when the opening angle exceeds 90 degrees and it exceeds a dead point with respect to gravity (vertical direction). Incidentally, in the embodiment, the rotation angle from the first position to the second position in the merging guide 102 is less than 90 degrees, however, the present invention is not limited to this, but it may be 90 degrees or more. In this case, it is possible to apply the configuration so that the opening state is ensured when the opening angle exceeds 90 degrees and it exceeds a dead point with respect to gravity (vertical direction).

Part (a) of FIG. 8 is a side view of the upper unit 101 and the merging guide 102 when they are viewed from the positive side to the negative side in the X direction, in a state that the upper unit 101 is fully opened and is rotated by 23 degrees around the upper rotational shaft 101a from a closed state. Part (b) of FIG. 8 is a sectional view showing a state when they are cut along line C-C in part (a) of FIG. 8. At this time, the opening angle of the merging guide 102 is 34 degrees. In this state, the lever 105 and the roller 104 are separated in the Z direction, however, according to a moment which is shown in FIG. 7, the moment in the opening direction which is caused by the tension coil spring 103 is greater than the moment in the closing direction which is caused by the weight of the merging guide 102. As a result, the merging guide 102 stands upright by exceeding its own weight. As described above, it is possible to open the merging guide 102 in interrelation with an operation of opening the upper unit 101.

That is, in a case in which the merging guide 102 is positioned in the third position and the upper unit 101 rotates from the fourth position toward the fifth position and then rotated to a sixth position where the engagement of the roller 104 and the lever 105 is released, the engagement of the roller 104 and the lever 105 is released. Further, in a case in which the merging guide 102 is positioned in the second range (the opening angle is from 10 degrees to 34 degrees), it is possible to rotate the merging guide 102 independently of the upper unit 101 without engaging the roller 104 with the lever 105. Therefore, it may be designed to close in interrelation with the rotation of the upper unit 101, or it may be designed to close independently of the upper unit 101.

### Closing operation of merging guide in coordination with upper unit

Next, a closing operation of the merging guide 102 in interrelation with the upper unit 101 will be described with reference to part (a) and part (b) of FIGS. 9. Part (a) of FIG. 9 is a side view of the upper unit 101 and the merging guide 102 when they are viewed from the positive side to the negative side in the X direction in a state that the upper unit 101 is opened by only 11 degrees when the upper unit 101 is closed by 12 degrees from a state that the upper unit 101 which is shown in part (a) and part (b) of FIG. 8 is opened by 23 degrees. Part (b) of FIG. 9 is a sectional view showing a state when they are cut along line D-D in part (a) of FIG. 9.

At this time, the merging guide 102 is closed by 19 degrees with respect to a state that it is opened by 34 degrees which is shown in part (a) and part (b) of FIG. 8, and the opening angle is 15 degrees. As the upper unit 101 is closed, a non-sheet passing area of the conveying guide portion 101d of the upper unit 101 contacts the roller 104 which is provided with the merging guide 102, and the merging guide 102 is pressed by the conveying guide portion 101d and closed in interrelation with the conveying guide portion 101d. At that time, since the roller 104 is closed while it is rolling with respect to the conveying guide portion 101d, it is possible to operate to close smoothly without being caught or damaged even though the roller 104 contacts the conveying guide portion 101d. When it is continued to be closed and the merging guide 102 is positioned in the first range (the opening angle between 0 degree to 10 degrees), the roller 104 engages with the lever 105, and the upper unit 101 and the merging guide 102 are closed as shown in part (a) and part (b) of FIG. 4. That is, in a case in which the merging guide 102 is positioned in the first range (the opening angle is between 0 degree and 10 degrees) and the roller 104 is engaged with the lever 105, the merging guide 102 rotates in interrelation with the upper unit 101. As described above, it is possible to close the merging guide 102 in interrelation with the closing operation of the upper unit 101.

That is, in a case in which the merging guide 102 is positioned in the second position and the upper unit 101 rotated from a state that it is positioned in the fifth position toward the fourth position, and the roller 104 engages with the lever 105 when it reaches the sixth position. Therefore, the merging guide 102 is rotated in interrelation with the upper unit 101.

### Closing operation of upper unit in a case in which merging guide is closed beforehand

Next, in a case in which the merging guide 102 is closed before the upper unit 101 is closed, an operation of the upper unit 101 will be described with reference to from part (a) of FIG. 10 through part (b) of FIG. 12. Part (a) of FIG. 10 is a side view of the upper unit 101 and the merging guide 102 when they are viewed from the positive side to the negative side in the X direction, in a state that the upper unit 101 is opened by 23 degrees and the merging guide 102 is closed. Part (b) of FIG. 10 is a sectional view showing a state when they are cut along line E-E in part (a) of FIG. 10. In a case in which the opening angle of the merging guide 102 is below 10 degrees, the moment of weight of the merging guide 102 is greater than the moment of the tension coil spring 103, it is possible to closed only the merging guide 102 without being in interrelation with the upper unit 101.

Next, part (a) of FIG. 11 is a side view of the upper unit 101 and the merging guide 102 when they are viewed from the positive side to the negative side in the X direction in a state that the upper unit 101 is opened by only 5 degrees when the upper unit 101 is closed by 19 degrees from a state that the upper unit 101 is opened by 23 degrees. Part (b) of FIG. 11 is a sectional view showing a state when they are cut along line F-F in part (a) of FIG. 11. At this time, an inclined surface 105c which is formed in a lower portion of the lever 105 which is provided with the upper unit 101 contacts the roller 104 which is provided with the merging guide 102, and the state is maintained. In a case in which the merging guide 102 is positioned in the first range (the opening angle is between 0 degree and 10 degrees) and the roller 104 is not engaged with the lever 105, the merging guide 102 rotates independently of the upper unit 101.

Next, part (a) of FIG. 12 is a side view of the upper unit 101 and the merging guide 102 when they are viewed from the positive side to the negative side in the X direction in a state that the upper unit 101 is opened by only 3 degrees when the upper unit 101 is furthermore closed by 2 degrees. Part (b) of FIG. 12 is a sectional view showing a state when they are cut along line G-G in part (a) of FIG. 12. As shown in part (b) of FIG. 11, when the inclined surface 105c of the lever 105 contacts the roller 104, a moment, in an opposite direction to that of contacting the contacting surface 101c with the lever 105 by the twisted coil spring 106 with respect to the rotational shaft 105a of lever 105, is generated. In this state, when the lever 105 is pushed down, the lever 105 rotates and retracts from the roller 104 in the -X direction as shown in part (a) and part (b) of FIG. 12.

Aftar that, when the upper unit 101 is furthermore closed, the upper unit 101 and the merging guide 102 are closed as shown in part (b) of FIG. 4. At this time, the lever 105 returns to its original position as shown in part (b) of FIG. 4 by the twisted coil spring 106 and the lever 105 engages with the roller 104. That is, the roller 104 crosses the inclined surface 105c of the lever 105 as the upper unit 101 descends and the roller 104 engages with the lever 105. That is in a case in which the merging guide 102 is positioned in the first position and the upper unit 101 is rotated from the state in which the upper unit 101 is positioned in the fifth position toward the fourth position, the lever 105 of the merging guide 102 positioned in the first position with rotation of the upper unit 101 is engaged with the roller 104. As described above, in a case in which the merging guide 102 is positioned in the first range (the opening angle is between 0 degree and 10 degrees) and the lever 105 is positioned above the roller 104, the lever 105 is capable of passing below the roller 104 while moving downward. As described above, it is possible to close the upper unit 101 even when the merging guide 102 is closed before the upper unit 101.

As described above, according to the embodiment, in a case in which the merging guide 102 is positioned in the first range and the roller 104 is engaged with the lever 105, the merging guide 102 rotates in interrelation with the upper unit 101. Therefore, it is possible to pull up the merging guide 102 in interrelation with the upper unit 101, even in a case in which the merging guide 102 rotates upward against gravity. Therefore, for two rotatable members having mutually different rotational axes, by rotating one member, the other member is capable of rotating upward against gravity in interrelation with it. Therefore, it is possible to improve an operability during jam processing and maintenance.

Incidentally, in the embodiment which is described above, a case in which it is applied to the feeding module 100 as one of examples of the sheet conveying device is described, however, the present invention is not limited to this. For example, it may be applied to the printing module 200, or it may be applied to other modules. Furthermore, the feeding module 100 and the printing module 200 may also be a sheet conveying device, or the inkjet recording system 1 as a whole may also be as a sheet conveying device. Any combination of modules which includes the feeding module 100 within the inkjet recording system 1 may also be a sheet conveying device.

Further, in the embodiment which is described above, a case in which an image forming system is applied to the inkjet recording system 1 of an inkjet recording type is described, however, the present invention is not limited to this, but it may also be applied to an image forming apparatus of an electrophotographic type.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-176500 filed on October 8, 2024, which is hereby incorporated by reference herein in its entirety.

What is claimed is:

1. A sheet conveying device comprising:
a first rotatable member rotatable about a first rotational shaft, displaceable to a first position where the first rotatable member is closed, a second position where the first rotatable member is opened upward from the first position and a third position positioned between the first position and the second position, and including an engaging portion;
a second rotatable member rotatable about a second rotational shaft which is disposed in a direction crossing the first rotational shaft, displaceable to a fourth position where the second rotatable member is closed and a fifth position where the second rotatable member is opened upward from the fourth position, and including an engaged portion engageable with the engaging portion; and
an urging portion configured to urge so as to move the first rotatable member toward the first position in a case in which the first rotatable member is positioned in a first range from the first position to the third position, and to urge so as to move the first rotatable member toward the second position in a case in which the first rotatable member is positioned in a second range from the third position to the second position,
wherein in a state in which the first rotatable member is in the first position and the second rotatable member is in the fourth position, the engaging portion is engaged with the engaged portion, and in a case in which the first rotatable member is moved from the first position to the second position, the second rotatable member is moved to the fifth position and retained.

2. The sheet conveying device according to claim 1, wherein in a state in which the first rotatable member is in the second position and the second rotatable member is in the fifth position, in a case in which the first rotatable member is moved from the second position to the first position, the second rotatable member is moved to the fourth position and the engaging portion is engaged with the engaged portion.

3. The sheet conveying device according to claim 1, wherein in a state in which the first rotatable member is positioned in the first range, and in a case in which the engaged portion is positioned below the engaging portion, the engaged portion is engaged with the engaging portion not to exceed upward with respect to the engaging portion, and
wherein in a case in which the first rotatable member is positioned in the first range and the engaged portion is positioned above the engaging portion, the engaged portion is capable of passing below the engaging portion while moving downward.

4. The sheet conveying device according to claim 1, wherein in a case in which the first rotatable member is positioned in the first position and the second rotatable member is rotated from the fourth position toward the fifth position and then rotated to a sixth position where engagement of the engaging portion and the engaged portion is released, the engagement of engaging portion and the engaged portion is released, and
wherein in a case in which the second rotatable member is rotated from the sixth position toward the fifth position, the first rotatable member is rotated independently of the second rotatable member.

5. The sheet conveying device according to claim 4, wherein in a case in which the first rotatable member is positioned in the second position and the second rotatable member is rotated from a state in which the second rotatable member is positioned in the fifth position toward the fourth position, the engaging portion is engaged with the engaged portion when the second rotatable member reaches the sixth position and the first rotatable member is rotated in interrelation with the second rotatable member, and
wherein in a case in which the first rotatable member is positioned in the first position and the second rotatable member is rotated from the state in which the second rotatable member is positioned in the fifth position toward the fourth position, the engaging portion of the first rotatable member positioned in the first position is engaged with the engaged portion with rotation of the second rotatable member.

6. The sheet conveying device according to claim 1,
wherein the urging portion is defined as a second urging portion,
wherein the engaged portion includes a hook rotatably supported between an engaging position engaging with the engaging portion and a retracted position retracted from the engaging position, and a first urging portion configured to urge the hook toward the engaging position, and
wherein in a state in which the first rotatable member is in the second position and the second rotatable member is in the fifth position, in a case in which the first rotatable member is moved from the second position to the first position, the hook causes the engaged portion to contact the engaging portion and rotate toward the retracted position against an urging force of the first urging portion by rotating the second rotatable member from the fifth position towards the fourth position, and is released from contact with the engaging portion when the second rotatable member is positioned in the fourth position and then is positioned in the engaging position by the urging force of the first urging portion.

7. The sheet conveying device according to claim 4, wherein in the case in which the first rotatable member is positioned in the third position and the second rotatable member is in the sixth position, the engagement of the engaging portion and the engaged portion is released, and
wherein in the case in which the first rotatable member is positioned in the second position and the second rotatable member is rotated from the state in which the second rotatable member is in the fifth position toward the fourth position, the engaged portion is engaged with the engaging portion when the second rotatable member reaches the sixth position.

8. The sheet conveying device according to claim 1, wherein the first position is a horizontal position, and
wherein a rotation angle from the first position to the second position in the first rotational member is less than 90 degrees.

9. The sheet conveying device according to claim 1, wherein the urging portion is defined as a second urging portion, and
wherein an urging force of the second urging portion is smaller than moment of weight of the first rotatable member in the case in which the first rotatable member is positioned in the first range, and is larger than the moment of weight of the first rotatable member in the case in which the first rotatable member is positioned in the second range.

10. The sheet conveying device according to claim 1, wherein the first rotatable member includes a first guide portion disposed below the second rotatable member and opposing the second rotatable member positioned in the fourth position in a case of positioning in the first position,
wherein the second rotatable member includes a second guide portion opposing the first rotatable member positioned in the first position in a case of positioning in the fourth position, and
wherein the first guide portion and the second guide portion form a first conveying passage through which the sheet is conveyed between the first guide portion and the second guide portion.

11. The sheet conveying device according to claim 1, further comprising a lower guide member disposed below the first rotatable member positioned in the first position,
wherein the first rotatable member includes a third guide portion opposing the lower guide member in a case of positioning in the first position, and
wherein the third guide portion and the lower guide member form a second conveying passage through which the sheet is conveyed between the third guide portion and the lower guide member.

12. The sheet conveying device according to claim 1, wherein the second rotational shaft is disposed along a sheet conveyance direction of the sheet which is conveyed, and
wherein the first rotational shaft is disposed along a widthwise direction perpendicular to the sheet conveyance direction.

13. An image forming system comprising:
a sheet conveying device according to claim 1; and
an image forming apparatus including an image forming portion configured to form an image on a sheet conveyed by the sheet conveying device.
